(19) United States
(12) Patent Application Publication
(10) Pub. No.: US 2016/0306291 A1
(43) Pub. Date: Oct. 20, 2016

(54) DEVELOPING DEVICE AND IMAGE FORMING APPARATUS

(71) Applicant: FUJI XEROX CO., LTD., Tokyo (JP)

(72) Inventors: Yoshitaka KURODA, Kanagawa (JP); Kiyohito HORII, Kanagawa (JP); Atsushi FUNADA, Kanagawa (JP)

(21) Appl. No.: 14/879,687

(22) Filed: Oct. 9, 2015

(30) Foreign Application Priority Data
Apr. 20, 2015 (JP) 2015-085799

(51) Int. Cl. G03G 15/08

(52) U.S. Cl. CPC G03G 15/0865

(57) ABSTRACT

A developing device includes a developing housing, a developer holding body, and a discharge channel forming member. The developing housing includes a container member which contains developer. The developer holding body is rotated while holding the developer on an outer surface thereof. The discharge channel forming member forms a discharge channel between the discharge channel forming member and an inner wall surface of the developing housing along the outer surface of the developer holding body so as to discharge air to the outside of the container member. The developing housing has a developer discharge portion through which excess developer is discharged to an outside on a one end side of the container member. The discharge channel has at least one first region and another region. The discharge channel is narrower at least in the at least one first region than in the other region.

### CROSS-REFERENCE TO RELATED APPLICATIONS

This application is based on and claims priority under 35 USC 119 from Japanese Patent Application No. 2015-085799 filed Apr. 20, 2015.

### BACKGROUND

### Technical Field

The present invention relates to a developing device and an image forming apparatus.

### SUMMARY

According to an aspect of the present invention, a developing device includes a developing housing, a developer holding body, and a discharge channel forming member. The developing housing has an inner wall surface and includes a container member which has one end and which contains developer. The developer holding body has one end and an outer surface, is supported by the developing housing, and is rotated while holding the developer on the outer surface thereof. The discharge channel forming member forms a discharge channel between the discharge channel forming member and the inner wall surface of the developing housing along the outer surface of the developer holding body so as to discharge air from an inside of the container member to an outside of the container member. The developing housing has a developer discharge portion through which excess developer is discharged to an outside on a one end side of the container member. The discharge channel has at least one first region and another region. The at least one first region is formed corresponding to a specified range of the developer holding body from a one end side of the developer holding body. The discharge channel is narrower at least in the at least one first region than in the other region.

### BRIEF DESCRIPTION OF THE DRAWINGS

Exemplary embodiment of the present invention will be described in detail based on the following figures, wherein:

FIG. 1 is a schematic sectional view of an internal structure of an image forming apparatus;

FIG. 2A is a perspective view of an overall structure of a developing device, and FIG. 2B is a perspective view of part of the developing device on a developer discharge portion side seen from a bottom surface side;

FIG. 3 is a longitudinal sectional view of the developing device also illustrating a photosensitive drum;

FIGS. 4A and 4B are schematic views of the structure of a discharge channel;

FIG. 5 is a longitudinal sectional view illustrating a flow of air in the discharge channel;

FIGS. 6A and 6B are schematic views of part of the image forming apparatus illustrating discharge of excess developer;

FIG. 7A is a schematic view illustrating flowing in of toner of another color through a developer discharge port, and FIG. 7B is a partial cut-away perspective view illustrating the flow of the toner of the other color flowing in through the developer discharge port; and

FIG. 8A illustrates the relationship between the discharge channel and a toner cloud amount, and FIG. 8B illustrates the relationship between the discharge channel and internal pressure of the developing device.

### DETAILED DESCRIPTION

Next, an embodiment and specific examples according to the present invention will be described with reference to the drawings in further detail below. It should be understood that the present invention is not limited to the embodiment and specific examples.

Furthermore, it should be noted that the drawings referred to in the following description are schematically illustrated and not to scale, and illustration of elements not required for the description is omitted as appropriate for ease of understanding.

For ease of understanding of the description hereafter, the front-rear direction, the left-right direction, and the vertical direction are respectively defined as the X direction, the Y direction, and the Z direction in the drawings.

### (1) An Overall Structure and Operations of an Image Forming Apparatus

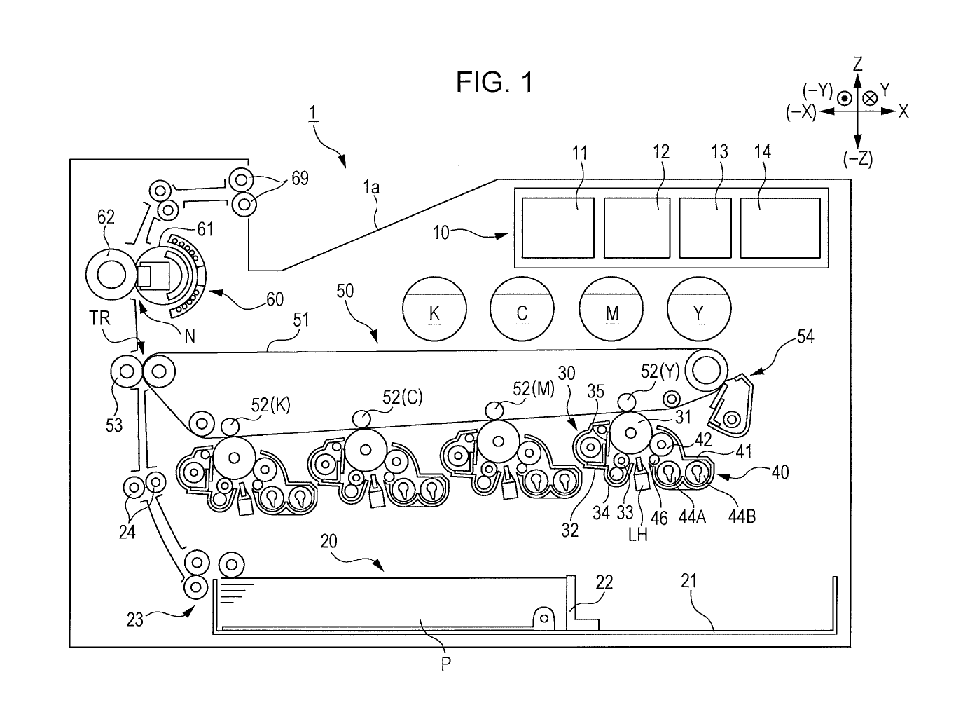

FIG. 1 is a schematic sectional view of an internal structure of an image forming apparatus 1 according to the present exemplary embodiment.

An overall structure and operations of the image forming apparatus 1 are described below with reference to the drawings.

The image forming apparatus 1 includes a controller 10, a sheet feed device 20, photosensitive units 30, developing devices 40, a transfer device 50, and a fixing device 60. An output tray la is formed on an upper (+Z direction) surface of the image forming apparatus 1. Sheets of paper in which images are recorded are output to and received by the output tray 1a.

The controller 10 includes components such as an image-forming-apparatus controller 11, a data converter 12, a light exposure controller 13, and a power source unit 14. The image-forming-apparatus controller 11 controls operations of the image forming apparatus 1. The data converter 12 prepares image data in response to a print processing request. The light exposure controller 13 controls turning on of a light exposure devices LH. The power source unit 14 applies high voltages to components such as charging rollers 32, developing rollers 42, first transfer rollers 52, and a second transfer roller 53, which are to be described later. The power source unit 14 also supplies power to the light exposure devices LH, the sheet feed device 20, the fixing device 60, and sensors and the like provided in these components.

The data converter 12 converts print information received from an external information transmission device (for example, a personal computer or the like) into image information for forming a latent image and outputs this image information to the light exposure devices LH in the form of drive signals at preset timing. The light exposure devices LH according to the present exemplary embodiment each include a light-emitting-diode (LED) head in which plural LEDs are linearly arranged in a main scanning direction.

The sheet feed device 20 is provided at a bottom portion of the image forming apparatus 1. The sheet feed device 20 includes a sheet loading plate 21. Many sheets of paper P are loaded on an upper surface of the sheet loading plate 21. The sheets P each serve as a recording medium. The sheets P are loaded on the sheet loading plate 21. The position of each of the sheets P in the width direction loaded on the sheet loading plate 21 is determined by a regulating plate (not illustrated). The sheets P are drawn forward (−X direction) one after another from the uppermost sheet by a sheet drawing member 22 and then transported to a nip of a registration roller pair 23.

The photosensitive units 30 are arranged parallel to one another above (+Z direction) the sheet feed device 20 and include respective photosensitive drums 31, which are rotated. The charging roller 32, the light exposure device LH, the developing device 40, the first transfer roller 52, and a cleaning blade 34 are arranged around each of the photosensitive drums 31 in a rotating direction of the photosensitive drum 31. A cleaning roller 33 that cleans a surface of the charging roller 32 is disposed so as to face and be in contact with the charging roller 32.

The developing device 40 includes a developing housing 41 that contains developer therein. The developing roller 42 and a pair of transport augers 44A and 44B are disposed in the developing housing 41. The developing roller 42 that serves as a developer holding body faces the photosensitive drum 31. The transport augers 44A and 44B are disposed on a lower rear side of the developing roller 42. The transport augers 44A and 44B agitate the developer and transport the developer to the developing roller 42 side. A layer thickness regulating member 46 that regulates the thickness of a layer of the developer is disposed near the developing roller 42.

There are no big differences between the structures of the developing devices 40 except for the developer contained in the developing housing 41. Yellow (Y), magenta (M), cyan (C), and black (K) toner images are formed by the respective developing devices 40.

The surface of the rotating photosensitive drum 31 is charged by the charging roller 32. An electrostatic latent image is formed on the charged surface of the photosensitive drum 31 by latent-image forming light emitted from the light exposure device LH. The electrostatic latent image formed on the photosensitive drum 31 is developed into a toner image by the developing roller 42.

The transfer device 50 includes an intermediate transfer belt 51 and first transfer rollers 52. The toner images of the colors formed on the photosensitive drums 31 of the photosensitive units 30 are transferred onto the intermediate transfer belt 51 so as to be superposed on one another. The first transfer rollers 52 sequentially transfer (first transfer) the toner images of the colors formed by the photosensitive units 30 onto the intermediate transfer belt 51. The transfer device 50 further includes the second transfer roller 53 and an intermediate-transfer-belt cleaner 54. The second transfer roller 53 collectively transfers (second transfer) the toner images of the colors having been transferred onto the intermediate transfer belt 51 so as to be superposed on one another onto the sheet P that serves as the example of the recording medium. The intermediate-transfer-belt cleaner 54 removes residual toner attracted to the intermediate transfer belt 51.

The toner images of the colors formed by the photosensitive drums 31 of the photosensitive units 30 are sequentially electrostatically transferred (first transfer) onto the intermediate transfer belt 51 by the first transfer rollers 52 to each of which a specified transfer voltage is applied from the power source unit 14 or the like controlled by the image-forming-apparatus controller 11. Thus, superposed toner images formed of the toner images of the colors superposed one another are formed.

Due to a movement of the intermediate transfer belt 51, the superposed toner images on the intermediate transfer belt 51 are transported to a region (second transfer portion TR) where the second transfer roller 53 is disposed. When the superposed toner images are transported to the second transfer portion TR, the sheet P is supplied from the sheet feed device 20 to the second transfer portion TR at timing adjusted to the transportation of the superposed toner images. A specified transfer voltage is applied from the power source unit 14 or the like controlled by the image-forming-apparatus controller 11 to the second transfer roller 53, thereby collectively transferring the superposed toner images from the intermediate transfer belt 51 onto the sheet P fed by the registration roller pair 23 and guided by a transport guide.

The residual toner on the surfaces of the photosensitive drums 31 is removed by the cleaning blades 34 and collected in a waste toner collection container or waste toner collection containers (not illustrated). The surfaces of the photosensitive drums 31 are charged again by the charging rollers 32. Remaining matter that has not been removed by the cleaning blades 34 and is attracted to the charging rollers 32 is captured by the surfaces of the cleaning rollers 33, which are rotated and in contact with the charging rollers 32, and accumulated.

The fixing device 60 includes a heating module 61 and a pressure module 62. A fixing nip N (fixing region) is defined in a region where the heating module 61 and the pressure module 62 are in pressure contact with each other.

The sheet P onto which the toner images have been transferred by the transfer device 50 but have not yet been fixed is transported to the fixing device 60 through the transport guide. The sheet P transported to the fixing device 60 is subjected to pressure and heat applied thereto by a pair of the heating module 61 and the pressure module 62. Thus, the toner images are fixed.

The sheet P on which a fixed toner image has been formed is output from an output roller pair 69 to the output tray 1a in the upper surface of the image forming apparatus 1.

### (2) The Structure and Operations of the Developing Devices

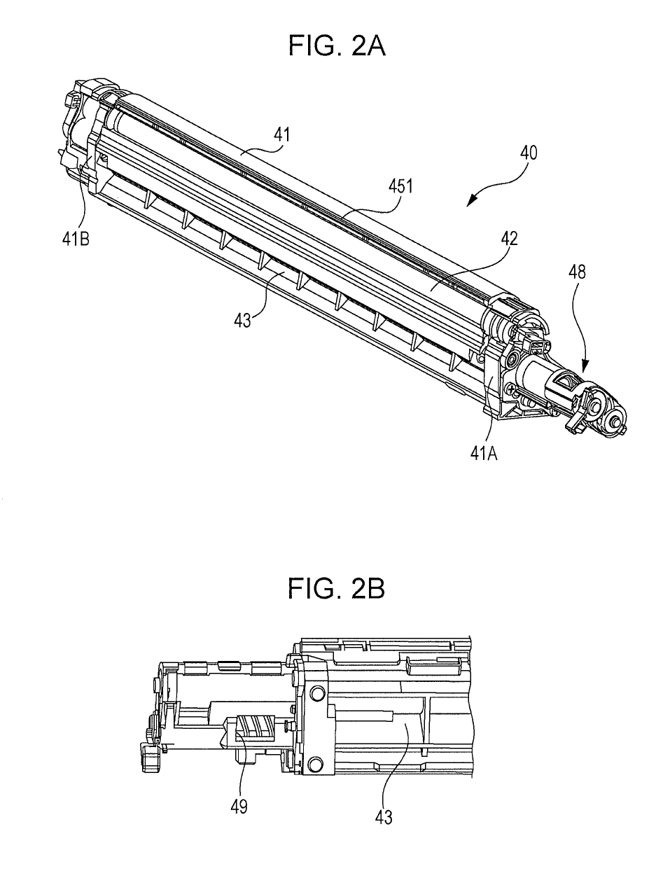

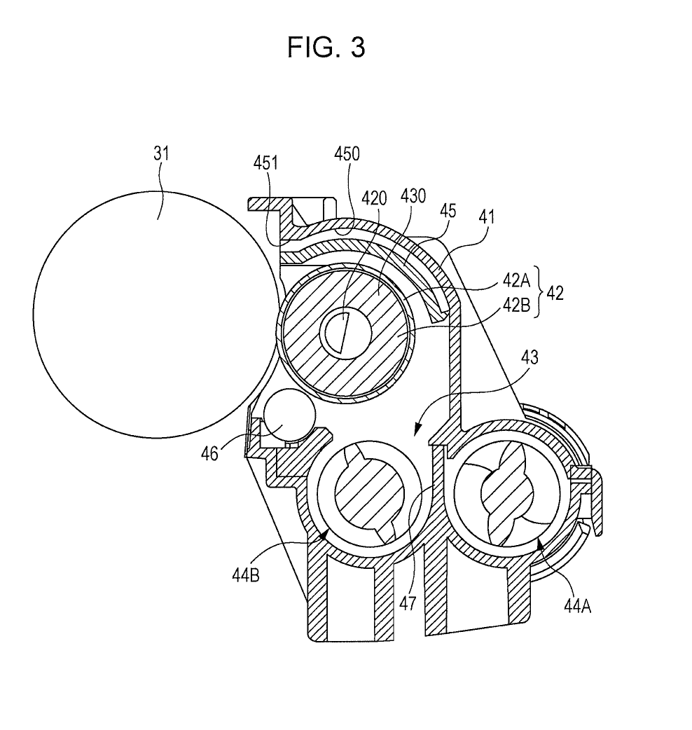

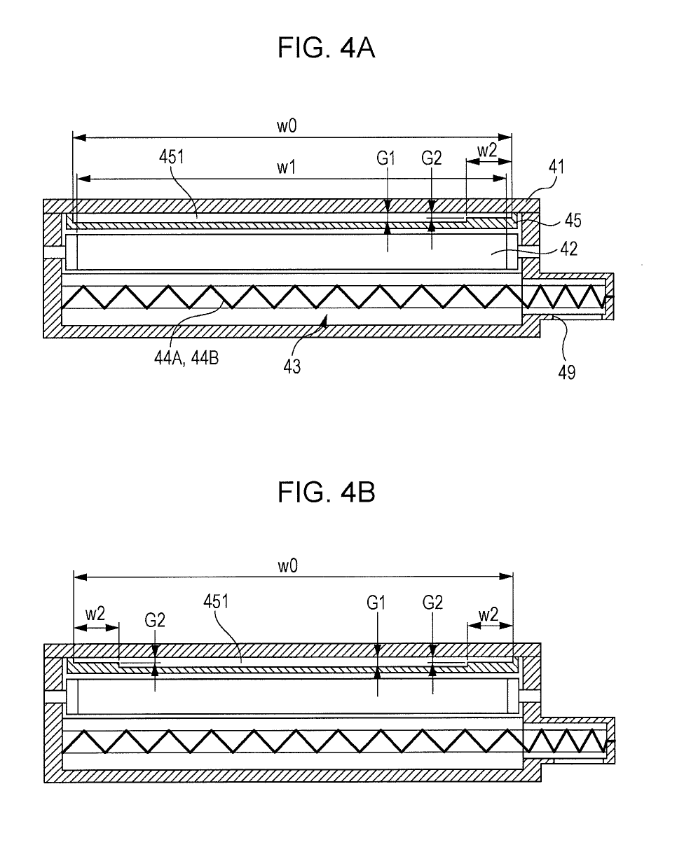

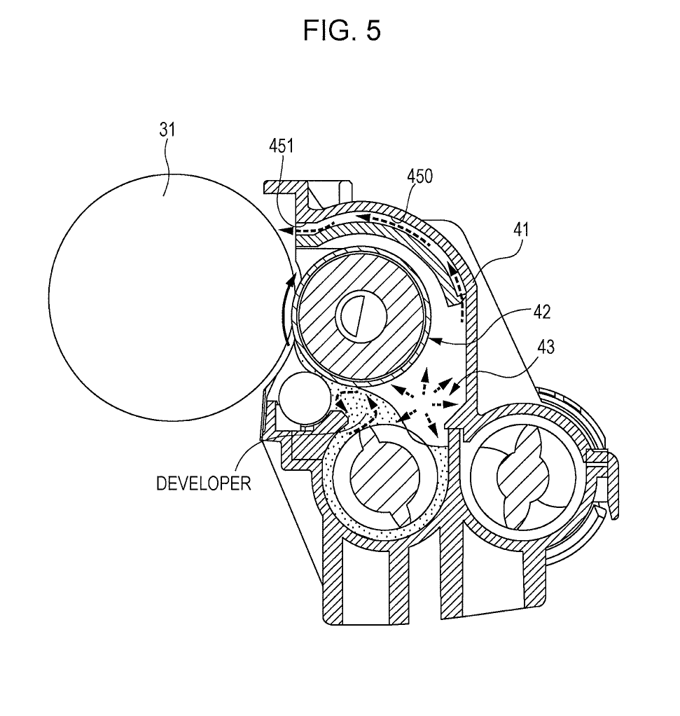

FIG. 2A is a perspective view illustrating an overall structure of each of the developing devices 40. FIG. 2B is a perspective view of part of the developing device 40 on a developer discharge portion side seen from a bottom surface side. FIG. 3 is a longitudinal sectional view of the developing device 40 also illustrating the photosensitive drum 31 serving as an image holding body. FIGS. 4A and 4B are schematic views of the structure of a discharge port. FIG. 5 is a longitudinal sectional view illustrating a flow of air in a discharge channel 450.

The structure and operations of the developing device 40 are described below with reference to the drawings.

### (2.1) The Overall Structure of the Developing Device

The developing housing 41 of each of the developing devices 40 has side plates 41A and 41B on both sides thereof. The developing roller 42 serving as an example of the developer holding body is rotatably supported by the side plates 41A and 41B.

The developing housing 41 has a developer chamber 43. The transport augers 44A and 44B are rotatably supported in the developer chamber 43. A partition 47 that isolates the transport augers 44A and 44B from each other stands erect at a central portion in sectional view of the developer chamber 43.

The developing housing 41 has a toner supply port 48, through which toner is supplied to the developer contained in the developer chamber 43, on one end side thereof. The toner is supplied from a toner cartridge (see FIG. 1) mounted in an image forming apparatus 1 body through a toner supply device (not illustrated). The toner is agitated with the developer containing magnetic carrier and non-magnetic toner and scooped up to the developing roller 42 by the transport augers 44A and 44B so as to be held by the developing roller 42.

A developer discharge port 49 is provided on the bottom surface side of the toner supply port 48. Excess developer out of the developer supplied together with the toner in the developer chamber 43 is discharged through the developer discharge port 49.

### (2.1) The Developing Roller

As illustrated in FIG. 3, the developing roller 42 faces an outer circumferential surface of the photosensitive drum 31 through an opening 41C formed in the developing housing 41. The developing roller 42 includes a developing sleeve 42A and a magnet 42B. The developing sleeve 42A that serves as an example of a cylindrically shaped cylindrical member is rotatably supported relative to the developing housing 41. The magnet 42B that serves as an example of a columnar magnetic member is provided in an inner space of the developing sleeve 42A and secured to the developing housing 41.

The developing sleeve 42A is rotated by a rotating drive force received from a drive unit (not illustrated) of the image forming apparatus 1 body. The developer is held on an outer circumferential surface of the developing sleeve 42A by a magnetic force of the magnet 42B. The developer is transported and supplied to the electrostatic latent image on the photosensitive drum 31 by the rotation of the developing sleeve 42A.

The magnet 42B of the developing roller 42 includes a shaft portion 420 and a magnetic portion 430. The shaft portion is formed of a non-magnetic material such as stainless steel (SUS). The magnetic portion 430 is formed of a magnetic material provided at an outer circumference of the shaft portion 420.

Both end portions of the shaft portion 420 in the axial direction are secured to both the side plates 41A and 41B of the developing housing 41. The developing sleeve 42A is rotatably supported at part of the shaft portion 420 located further to the inside in the axial direction than both the portions secured to the developing housing 41.

### (2.3) The Layer Thickness Regulating Member

The layer thickness regulating member 46 is secured to the developing housing 41 at a position upstream of the photosensitive drum 31 in a rotating direction of the developing roller 42 on the lower side of the photosensitive drum 31 and the developing roller 42. A specified gap is maintained between the layer thickness regulating member 46 and an outer circumferential surface of the developing roller 42.

The layer thickness regulating member 46 is formed of a magnetic body having a columnar shape. Examples of this magnetic body include generally used low-carbon steel and ferritic stainless steel.

A holding force that holds the developer is produced by a magnetic force of the magnetic body in the layer thickness regulating member 46. Part of the developer held by the developing roller 42 is removed from the developing roller 42 by this holding force. Thus, the thickness of the layer of the developer is regulated to a predetermined thickness.

### (2.4) Discharge Channel Forming Member

A discharge channel forming member 45 extends along the outer circumferential surface of the developing roller 42 in a rotational axis direction of the developing roller 42 so as to cover part of the developing roller 42. Furthermore, the discharge channel 450, through which the air is discharged from the inside to the outside of the developer chamber 43, is formed between an inner wall surface of the developing housing 41 and the discharge channel forming member 45. The discharge channel forming member 45, which is supported by the developing housing 41 through a rib (not illustrated) formed on part of the inner wall surface of the developing housing 41, forms the discharge channel 450 having a predetermined opening.

A discharge port 451 of the discharge channel 450 is provided at a position closer to the photosensitive drum 31 than a top portion T of the developing roller 42 is.

### (2.5) The Discharge Channel

As illustrated in FIG. 4A, a width w0 of the discharge port 451 of the discharge channel 450 is more than a width w1 of the developing roller 42 in the rotational axis direction. Thus, the discharge port 451 extends along an entire region of the developing roller 42 in the rotational axis direction. Furthermore, an opening thickness G1 is 2 mm or less over the entire width of the discharge port 451.

The discharge port 451 has a first region having an opening thickness G2 and a width w2 on the developer discharge port 49 side. The opening thickness G2 is less than the opening thickness G1 of the width of the entire discharge port 451.

The opening thickness G1 of the entire width is 2 mm or less, the opening thickness G2 of the first region is 1 mm or less, and the width w2 of the first region in the rotational axis direction of the developing roller 42 is from 10 to 30 mm.

### Variation

As illustrated in FIG. 4B, the opening thickness of the discharge port 451 may be set as follows: the entire opening thickness G1 is 2 mm or less; and the opening thickness G2 of regions having a width w2 from both ends of the developing roller 42 is 1 mm or less, which is less than the entire opening thickness G1. Furthermore, the width w2 at each end in the rotational axis direction of the developing roller 42 is from 10 to 30 mm.

As illustrated in FIG. 5, the air in the developer chamber 43 flows through the discharge channel 450 and is discharged to the outside of the developing device 40 through the discharge port 451 in the developing device 40 having a structure as described above.

### (3) Operations

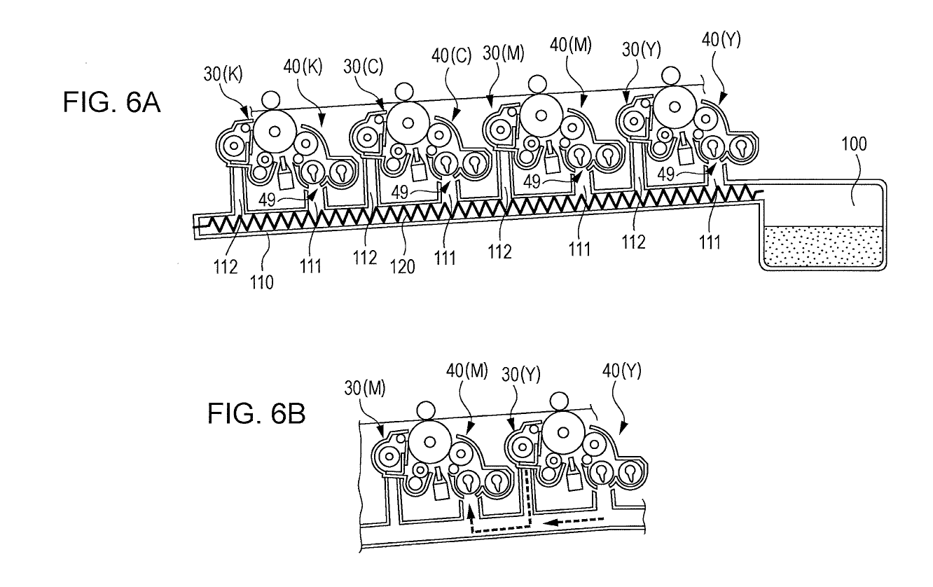

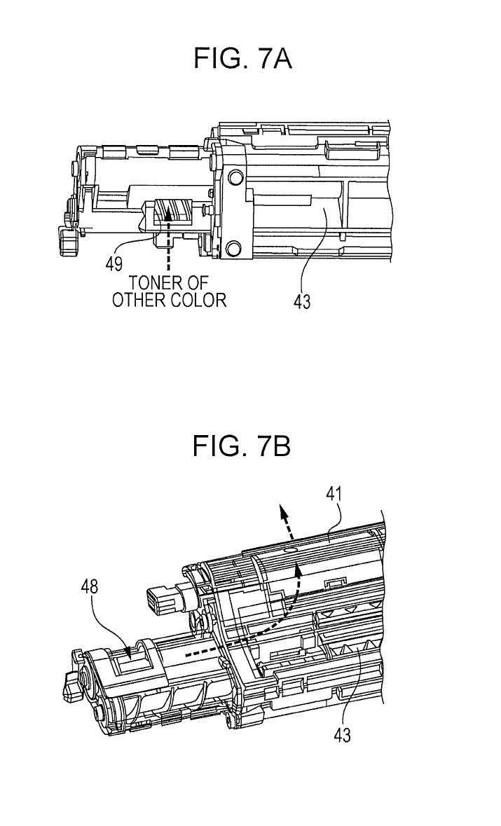

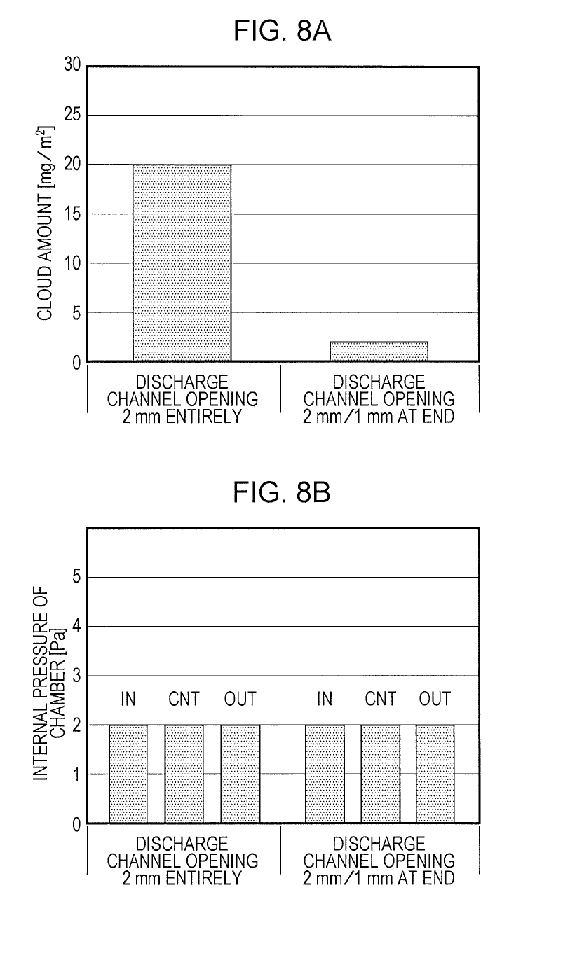

FIGS. 6A and 6B are schematic views of part of the image forming apparatus 1 illustrating discharge of excess developer in the image forming apparatus 1. FIG. 7A is a schematic view illustrating the toner of another color flowing in through the developer discharge port 49 and FIG. 7B is a partial cut-away perspective view illustrating the flow of the toner of the other color flowing in through the developer discharge port 49. FIGS. 8A and 8B illustrate the relationship between the discharge port and a toner cloud amount.

Operations of the developing device 40 are described below with reference to the drawings.

### (3.1) Backflow of Collected (Residual) Toner

Each of the photosensitive units 30 is disposed adjacent to a corresponding one of the developing devices 40 in the image forming apparatus 1 so as to form yellow (Y), magenta (M), cyan (C), and black (K) toner images.

As illustrated in FIG. 6A, the image forming apparatus 1 includes a developer collection container 100, a developer discharge path 110, and a transport member 120. Excess developer discharged from the developing devices 40 and residual toner discharged from the photosensitive units 30 are collected in the developer collection container 100. The developer discharge path 110 is connected to the developing devices 40, the photosensitive units 30, and the developer collection container 100. The transport member 120 transports the excess developer discharged from the developing devices 40 and the residual toner discharged from the photosensitive units 30 to the developer collection container 100.

The excess developer discharged from the developer discharge port 49 of each of the developing devices 40 drops into the transport member 120 through a corresponding one of connecting portions 111 of the developer discharge path 110.

Furthermore, the residual toner discharged from each of the photosensitive units 30 drops into the transport member 120 through a corresponding one of connecting portions 112 of the developer discharge path 110.

The excess developer and the residual toner are transported into the developer collection container 100 by a rotating helical blade of the transport member 120.

Meanwhile, it is assumed that the internal pressure increases in the developer chamber 43 of, for example, the developing device 40 (Y) that forms the yellow (Y) toner image adjacent to the developing device 40 (M) that forms the magenta (M) toner image. In this case, the residual toner of the Y color collected from the photosensitive unit 30 (Y) may flow back in the developer discharge path 110 and flow into the developer discharge port 49 of the adjacent developing device 40 (M) (see arrows in FIG. 6B).

As illustrated in FIGS. 7A and 7B, the Y-color residual toner having flowed into the developing device 40 (M) through the developer discharge port 49 of the developing device 40 (M) flows through the discharge channel 450 of the developing device 40 (M) and is discharged through the discharge port 451 of the developing device 40 (M). This may contaminate the interior of the image forming apparatus 1. Consequently, image formation may fail due to contamination of the intermediate transfer belt 51 and the color mixture may occur in the developing devices 40.

It is known that the residual toner to be collected is likely to flow back to the adjacent developing device 40 as described above when there is a difference in the internal pressure of the developer chamber 43 between the developing devices 40. It is known that such a difference in the internal pressure may be likely to be caused when, for example, there is a difference in the amount of developer between the developer chambers 43, there is a difference in distribution of the developer between the developer chambers 43, or when part of the discharge channel 450 is clogged by the developer or the like.

### (3.2) Results of an Experiment

FIG. 8A illustrates the amount of toner cloud (in mg/m²) from the discharge port 451 of a comparative example and the exemplary embodiment. The opening thickness G1 of the discharge port 451 of the discharge channel 450 is 2 mm over the entire region of the discharge port 451 of the comparative example. The discharge port 451 of the exemplary embodiment has the opening thickness G2 of 1 mm in the first region having the width w2 (10 to 30 mm) on the developer discharge port 49 side.

In this experiment, the toner cloud amount from the discharge port 451 is measured while printing is performed under the following conditions: the internal pressure of the developer chamber 43 of the developing device 40 (Y) is set to 4 Pa; and the internal pressure of the developer chamber 43 of the adjacent developing device 40 (M) is set to 2 Pa.

As illustrated in FIG. 8A, the toner cloud amount is, for example, 20 mg/m² with the comparative example and 2 mg/m² with the exemplary embodiment.

FIG. 8B illustrates measurement results of the inner pressure of the developer chamber 43 of the comparative example and that of the exemplary embodiment. The inner pressure is measured near an end (“OUT” in FIG. 8B), at a central portion (“CNT” in FIG. 8B), and in a middle portion (“IN” in FIG. 8B) of the developing device 40.

Referring to FIG. 8B, also with the exemplary embodiment, in which the discharge port 451 has the first region of the opening thickness G2 of 1 mm over the width w2 (10 to 30 mm) on the developer discharge port 49 side, the internal pressure of the developer chamber 43 is 2 Pa. That is, when the opening thickness G2 of the discharge port 451 is about 1 mm, the internal pressure of the developer chamber 43 does not necessarily increase compared to the comparative example in which the discharge port 451 of the discharge channel 450 has the opening thickness G1 of 2 mm over the entire region of the discharge port 451.

Although the exemplary embodiment of the present invention has been described in detail, the present invention is not limited to the above-described exemplary embodiment. Many variations are possible without departing from the gist of the present invention described in the claims. The opening thickness G2 of the first region of the discharge channel 450 formed by the inner wall surface of the developing housing 41 and the discharge channel forming member 45 may be reduced only at the discharge port 451 of the discharge channel 450.

The image forming apparatus according to the present exemplary embodiment having been described is of the tandem type with which the toner images of the colors are formed at a time. However, the developing device in which regions having the width w2 from both end sides of the developing roller 42 have the opening thickness G2 of 1 mm or less, which is less than the entire opening thickness G1, may also be applied to a monochrome image forming apparatus.

The foregoing description of the exemplary embodiment of the present invention has been provided for the purposes of illustration and description. It is not intended to be exhaustive or to limit the invention to the precise forms disclosed. Obviously, many modifications and variations will be apparent to practitioners skilled in the art. The embodiment was chosen and described in order to best explain the principles of the invention and its practical applications, thereby enabling others skilled in the art to understand the invention for various embodiments and with the various modifications as are suited to the particular use contemplated. It is intended that the scope of the invention be defined by the following claims and their equivalents.

1. An image forming apparatus comprising:
a developing device comprising:
a developing housing that has an inner wall surface and includes a container member which has one end and which contains developer;
a developer holding body that has one end and an outer surface, that is supported by the developing housing, and that is rotated while holding the developer on the outer surface thereof; and
a discharge channel forming member that forms a discharge channel between the discharge channel forming member and the inner wall surface of the developing housing along the outer surface of the developer holding body so as to discharge air from an inside of the container member to an outside of the container member,
wherein the developing housing has a developer discharge portion through which excess developer is discharged to an outside on a one end side of the container member,
wherein the discharge channel has at least one first region and another region,
wherein the at least one first region is formed corresponding to a specified range of the developer holding body from a one end side of the developer holding body, wherein the discharge channel is narrower at least in the at least one first region than in the other region,
wherein the discharge channel forming member has an outer wall surface, and
wherein the outer wall surface of the discharge channel forming member is closer to an inner wall surface side of the developing housing in the at least one first region than in the other region;
a developer collection container in which the excess developer discharged from the developing device is collected;
a developer discharge path connected to the developing device and the developer collection container: and
a transport member that is provided in the developer discharge path and that transports the excess developer discharged from the developing device to the developer collection container.

2. The image forming apparatus according to claim 1,
wherein the at least one first region is formed on a developer discharge portion side.

3. The forming apparatus according to claim 1,
wherein the at least one first region includes a plurality of first regions,
wherein the developer holding body has another end, and
wherein the plurality of first regions are respectively formed corresponding to the one end side and another end side of the developer holding body.

4. (canceled)

5. (canceled)
